(19) United States
(12) Patent Application Publication
(10) Pub. No.: US 2002/0175213 A1
(43) Pub. Date: Nov. 28, 2002

(54) Energy-saving automatic flame control at a gas cooktop

(76) Inventor: Josef Wodeslavsky, Tena Fly, NJ (US)

Correspondence Address: JOSEF WODESLAVSKY, #5 PETER LYNAS CT, TENA FLY, NJ, 07670, US

(21) Appl. No.: 09/862,028

(22) Filed: May 22, 2001

(51) Int. Cl. H05B 1/02; F23N 1/08

(52) U.S. Cl. 236/20 A; 219/516

(57) ABSTRACT

An automatic flame control at a gas cooktop that is designed to save gas and to minimize pollution while cooking with a flame of variable intensity depending on the temperature of the cooking utensil. It consists of a temperature-sensing device, attached to the cooktop rack, which measures the utensil's temperature. This sensing device sends an electrical signal to a control panel that consists of a thermostat to be controlled by the user. This control panel controls a gas flow restrictor valve that can alter the gas flow to the cooktop burner. The cooktop burner could be removable for service or cleaning, and a display to show the user at what temperature the food is being cooked could be installed. In addition, a controller can be adapted to this device to control the intensity of the low flame when the burner is on its low cycle.

### FIELD OF THE INVENTION

The need to control the heat intensity at a gas cooktop is known, since often the user does not know that a lot of heat escapes without doing any good and since food is often burned by the high intensity of the flame, and often people cause fires in the kitchen because of a lack of attention. This invention has the purpose of preventing the burning of food at gas cooktops, as well as saving gas during the cooking process, therefore both conserving scarce resources and protecting the environment from pollution.

### SUMMARY OF THE PRESENT INVENTION

There are few examples in the prior art that suggests automatic flame control at the gas cooktop. In U.S. Pat. Nos. 4,646,963 and 4,645,124, those existing devices are prone to heat damage and will eventually burn out. Since the existing devices are heat sensors that rise from the center of the burner, these sensors can only measure temperature at the center of the cooking utensil. My invention measures the temperature at the outer parts of the cooking utensil, an important improvement since cooking with too much heat causes a lot of heat to escape into the atmosphere, wasting gas and polluting the air. My invention will force the user to use the burner's flame more efficiently by having to act and reduce the flame. If the user employs too big a flame, my device will not only reduce the flame but after a certain amount of time an alarm in the form of a buzzing sound will alert the user that he is wasting energy. The existing devices are mechanically constructed with many moving parts that make them expensive and vulnerable to wearing out. They cause the burner flame to change gradually with changes in temperature, which often is not good for the cooking process. In addition, there is no way to control the interval and amount of cycles that the flame of the gas burner will go to high or low intensity and stay at a level of intensity for a set amount of time. This invention, which eliminates all these drawbacks, is based on the idea that some of the heat that warms the cooking utensil is transmitted to the rack on which said utensil stands. Therefore, as long as the utensil is cold, because it contains cold food, the rack upon which it stands is also cold. Conversely, once the utensil is heated, the rack is heated as well, so the temperature of the rack is influenced by the temperature of the cooking utensil. This invention is based on a temperature sensor that is situated on or in the rack and measures the heat that escapes and warns the user via a buzzer to reduce the intensity of the flame, and said sensor is connected to an electronic circuit that controls the intensity of the gas flame.

### BRIEF DESCRIPTION OF THE DRAWINGS

FIG. 1 will illustrate a gas cooktop that consists of a burner being controlled by a temperature-sensing device.

FIG. 2 will illustrate a gas cooktop rack embodiment that consists of a temperature-sensing device.

FIG. 3 will illustrate a gas cooktop rack with a different temperature-sensing device.

FIG. 4 will illustrate a gas restrictor valve with an adjustable gas flow restriction element.

### DETAILED DESCRIPTION OF THE DRAWINGS

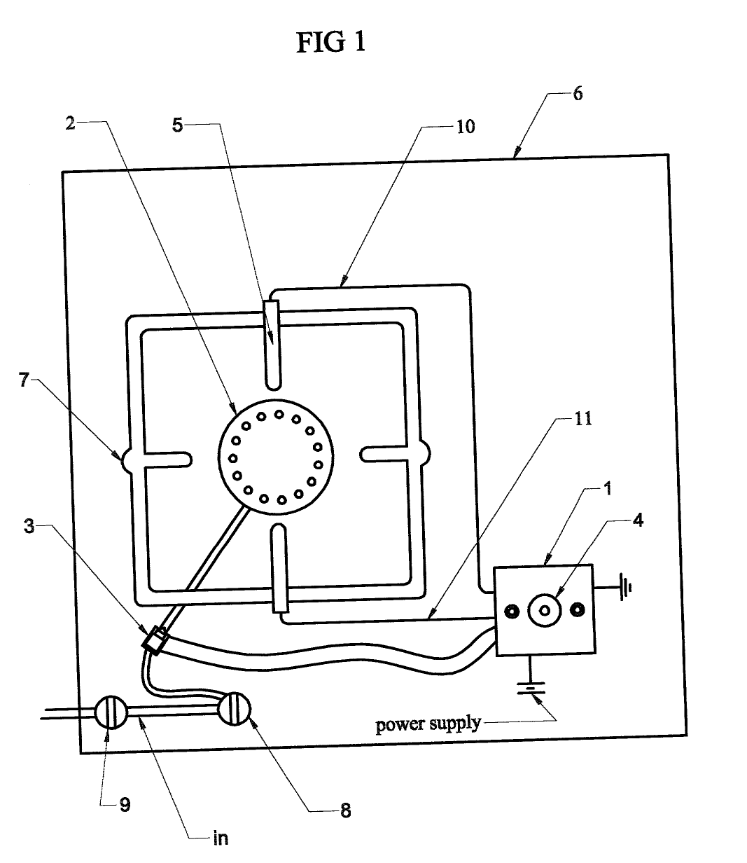

FIG. 1 will illustrate a cooktop 6, a burner 2, a rack 7, an electronic control panel 1, a thermostat 4, a gas control valve and shutoff valve 8, a temperature sensor 5, a main shutoff valve 9, and an electric control valve 3. Said valve 3 is normally open if no electrical power is flowing into it, so the gas that flows from valve 8 can reach burner 2. Once the power supply is activated, panel 1 will force valve 3 to the closed position. Only thermostat 4 can open or close the electrical circuit to valve 3. In order to open valve 3, thermostat 4 should be set to the “hot” position. If said thermostat is set in the “hot” position, the gas will flow to burner 2 and can be ignited. A cooking utensil should at this point be located on rack 7. At first the cold utensil will absorb the heat from the flame as well as from said rack, and as the utensil heats it will also warm said rack, so the temperature of the utensil and the food inside will determine the heat detected by temperature sensor 5. Said sensor 5 is mounted on rack 7 in a position that causes the cooking utensil to be situated on said sensor. To indicate the temperature of the utensil and rack, sensor 5 transmits a signal via leads 10 and 11. Said signal is processed by panel 1 and the setting of thermostat 4 will determine if valve 3 is to be closed (stopping or reducing the intensity of the flame at burner 2) or to be kept open. Valve 3 can be set so that it will be fully closed when commanded to be in the “closed” position or left slightly open at that command so that a small flame remains lit. If an automatic gas ignition burner is used, the burner can be fully closed, since when the command is made to open the gas flow again to the burner a spark will be automatically produced and the gas will again ignite.

Temperature sensor 5 can be made from known temperature-sensing devices such as electrical or electronic resistors that change their resistance as their temperature changes. Such electrical resistance changes will influence an electronic chip called a comparator which is part of the electrical circuit in panel 1. The output of thermostat 4, which is a potentiometer, indicates the degree of electrical resistance that has been set for it. Said potentiometer is also wired to said comparator, and said comparator analyzes the electrical resistance between the input from the temperature sensor 5 and thermostat 4, and such analysis will determine whether it opens or closes the gas flow to burner 2. Of course, the described technology based on the use of a comparator is only one method of accomplishing temperature control at the burner. Another known method is the use of a microprocessor that analyzes the electrical signal from said resistor and from the thermostat setting. The electronic circuit can also handle other functions, such as changing the length of time between cycles of opening and closing valve 3, to keep the flame intensity high or low for longer periods of time, to keep the flame constant after a given number of high flame-low flame cycles, or to extinguish the flame completely after cooking for a certain length of time. It should be noted that some metals change their electrical resistance as they undergo changes in temperature, so use of electronic resistors as a flame controller should be considered only one example. Another temperature sensor is called a thermocouple, which is made up of two wires, composed of different materials, which are connected. This type of sensor produces current under the influence of heat instead of resistance changes. There are many kinds of temperature sensors known today that could be used in this device, and the examples given should not be understood to limit the scope of the invention.

The type of restrictor valve previously described which changes from the open position to the closed position and vice-versa can be changed to a flow restrictor which is activated by a step motor or an electromagnet. A step motor moves to the open or closed position and can be stopped at any point in between those two settings. The coil of the electromagnet receives less or more power from the control panel, thus either opening or closing the restrictor valve, and also can be stopped at any point in between those two settings. Therefore the size of the gas flow, and thereby flame intensity, can be controlled by the electrical control panel equipped with a microprocessor, and the user also can select whatever intensity of the flame at the burner is desired. A potentiometer means can be adapted to the rack in order to measure the temperature and control the flame intensity automatically. Such potentiometer means are known in motor vehicle engines to measure the temperature of said engines. In addition, a display of the temperature can be adapted to said cooktop, and signal light or buzzer indicators can be disposed to show the user the position of the gas restrictor valve in either closed or restricted mode.

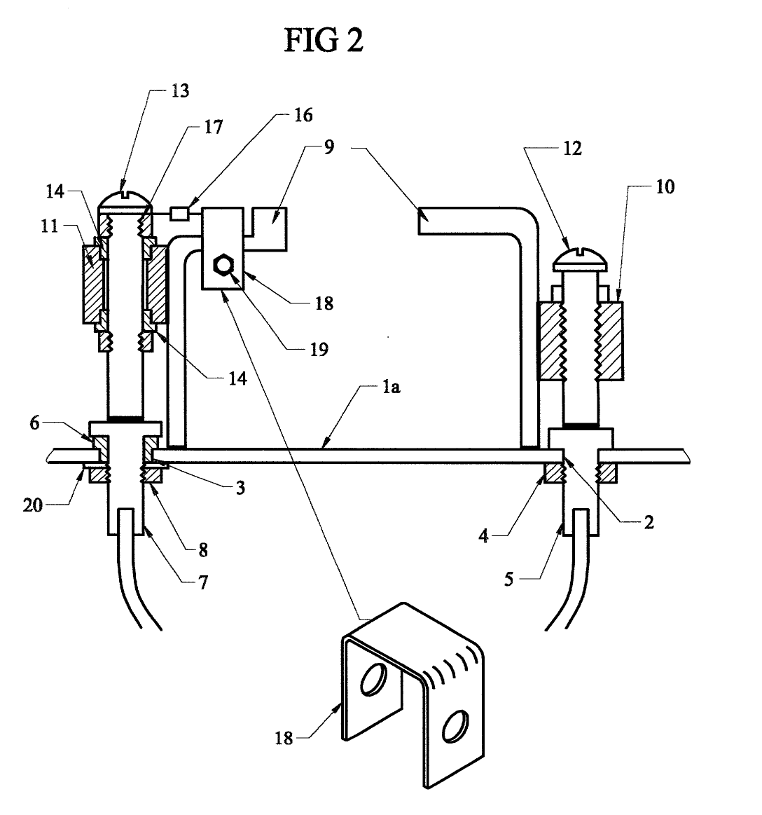

FIG. 2 will describe a method of transmitting the temperature signal from rack 7 to control panel 1. Since it is very important to preserve the appearance of the cooktop and keep it free of obstacles to the user, and since the rack and cooktop should both be easy to clean and possibly remove and replace, a specific design has been devised in order to transmit the electrical signal with no wires connecting said rack and said control panel.

In the cooktop sheet metal 1a there are two bores 2 and 3. Into bore 2 is placed a bolt 5 which is tightened by nut 4. Into bore 3 is placed a bushing 6 which is made from electrical insulated material. Into said bushing is placed bolt 7, which is tightened by nut 8. Onto rack 9 are welded two pipes, 10 and 11. Pipe 10 contains an inner thread into which bolt 12 is screwed until it touches the upper surface of bolt 5. Bolt 13 is inserted an electrical resistance bushing 14, which is located in pipe 11, so that bolt 13 is electrically insulated from rack 9. Bolt 13 is positioned to certain heights by nuts 15 and 16. The lower part of bolt 13 should touch the upper part of bolt 7 in order to maintain a close electrical circuit between them.

On the leg on the left side of rack 7 there is a recess like a step, and on said recess is placed a temperature-sensing device 16, which is a resistor constructed of resistant materials at the center and a wire on each end. One wire of temperature sensor 16 is tightened to bolt 13 by nut 17. The other wire of said sensor is unconnected, but leans on the recessed space of the rack. On said wire is mounted a U-shaped metal piece 18, which is preferably made of aluminum and hereafter termed the “adaptor.” Said adaptor leans on the unconnected wire of sensor 16 (a sketch of such an adaptor will be found at the bottom of sheet metal 1). When a cooking utensil is placed on rack 7, it will also sit on adaptor 18 since said adaptor is positioned a little higher than the rack legs. Therefore much of the heat emitted from the utensil surface touching adaptor 18 can be transmitted from said utensil to said adaptor and to the unconnected wire of sensor 16. Said adaptor can be held, but not firmly held, by screw 19 in such a way as to let said adaptor move and adjust to the bottom surface of the cooking utensil in order to maximize contact between the surface of said utensil and said adaptor. The described embodiment is designed to minimize maintenance problems, since at all times contact between rack 9 and bolts 5 and 7 must be maintained. During the life of the device the position of said bolts may have to be adjusted to maintain the electrical contact, which is easy to accomplish. Temperature-sensing device 16 can be easily replaced once it wears out. The same ease of replacement applies to adaptor 18. It should be noted that adaptor 18 could be designed to slide on the rack legs like on a rail in order to adjust it to different sizes of cooking utensils. Said adaptor could be fashioned in other shapes, such as an L-shape, in order to touch a cooking utensil on an outside vertical wall, allowing the sensor to take a temperature reading from both the bottom and side wall of the utensil or from the side wall only.

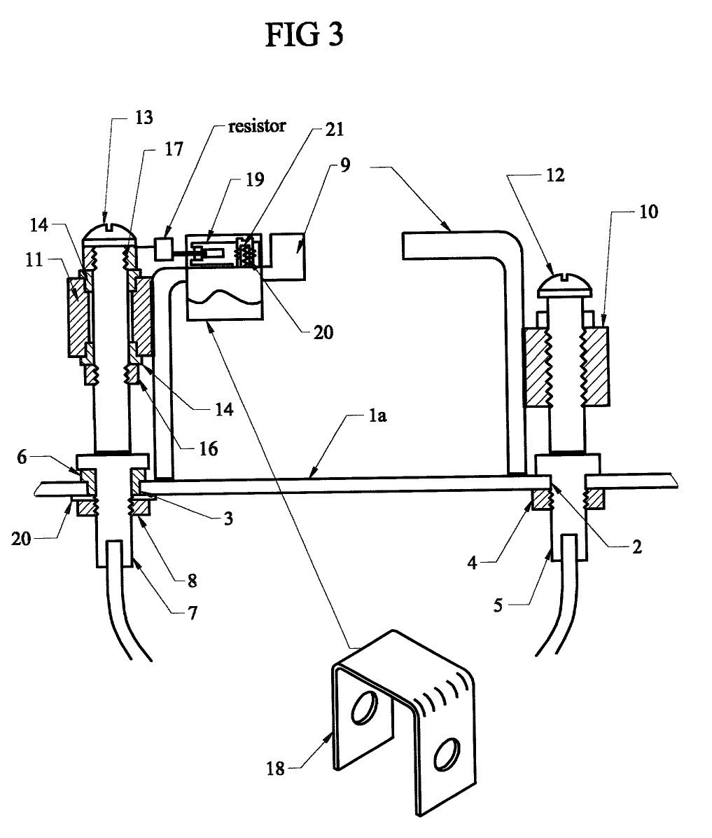

FIG. 3 will illustrate another method for a temperature-sensing device which is a bimetal 19 which is positioned on the rack instead of a resistor. Said bimetal will bend with an increase in temperature and will therefore act like a switch to open or close an electrical circuit. A spring 20 is biased by an adjustable screw 21 in order to change the heat point at which the bimetal bends and opens the electrical contact. It should be noted that the control panel 1 in FIG. 1 could be used for more than one burner. Since in most houses only one burner is in use at any given time, therefore the gas restrictor valve should be installed in an additional burner and rack assembly as in FIG. 2, and only a selector switch to redirect the signal from two bolts 12 and 13 is needed to transfer the power that activates or deactivates said restrictor valve 3 in FIG. 1.

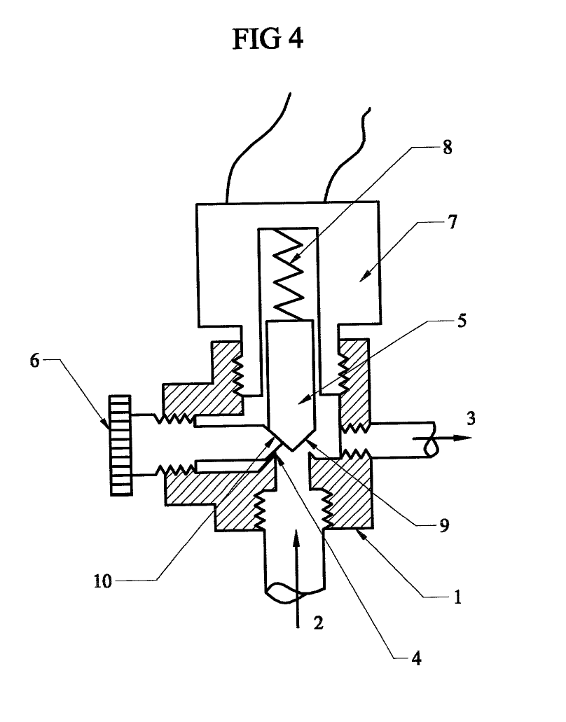

FIG. 4 will illustrate the gas restrictor assembly that accomplishes the adjustment of the low flame intensity, as there is a need to control the intensity of the flame once the control panel issues a command to decrease the intensity of the flame, since each item of food requires different temperatures to cook properly.

A valve housing 1 consists of a gas inlet 2 and a gas outlet 3, with a bore and a seat 4 on the end of inlet 2. A plunger 5 disposed on seat 4, and said plunger terminates in a cone shape. An adjustable screw 6 has a cone shape on the right side which matches the cone shape of plunger 5, and when they touch they make an angle of 90°. The position and depth of said screw 6 will determine the distance between plunger 5 and seat 4, determining how much gas will continue to flow once plunger 5 approaches seat 4. An electromagnet 7 is disposed in housing 1 and spring 8 pushes plunger 5 to the closed position once electromagnet 7 is deenergized. The complete gas restrictor assembly is mounted behind the control panel in such a way that screw 6 is exposed to the user so that the user has access in order to adjust the low-intensity flame.

It should be noted that a timer apparatus such as in a microwave oven can be adapted in order to let the user cook in more advanced ways. Furthermore, many “cooking patterns” can be added to the processor that controls the flame's intensity, like more or less time for each cycle of high or low flame, or more or less heat during each cycle.

It should be noted that the description of my invention as given here is not limited to the examples given, as many variations can be developed within the scope of this invention.

1. A gas burner to be used mostly for cooking, and said gas burner consists of a gas-feeding line for said burner which is controlled by a gas restrictor valve means which functions by electrical power, and said restrictor valve being fed gas which is controlled by a manual valve, and the electrical power which activates said gas restrictor means being controlled by an electrical control panel, and said burner is situated beneath a rack means which supports cooking utensils, and onto said rack means is adapted a variable electrical resisting means which changes its resistance status with temperature changes and it is connected to said control panel in order to measure the temperature of said cooking utensil which rests upon said rack means, and said variable electrical resisting means activates said control panel, and a second variable resisting means, which is a thermostat means, is adapted to said electrical panel in order to set the temperature at which said electrical panel will send a signal to said gas restrictor valve means in order to change the status of said gas restrictor valve means and therefore change the status of the gas flow from unrestricted flow to restricted flow between said manual gas valve and said burner.

2. A gas burner with a gas flow restrictor as in claim 1 whereby said temperature-sensing means which measures the temperature is an electrical resistor.

3. A gas burner with a gas flow restrictor as in claim 1 whereby said temperature-sensing means which measures the temperature is a thermocouple.

4. A gas burner with a gas flow restrictor as in claim 1 whereby said temperature-sensing means which measures the temperature is a bimetal.

5. A gas burner with a gas flow restrictor as in claim 1 which further consists of a temperature display.

6. A gas burner with a gas flow restrictor as in claim 1 which further consists of a status display regarding the gas restrictor valve.

7. A gas burner with a gas flow restrictor as in claim 1 whereby the control panel electrical circuit consists of a comparator chip which analyzes the signals from said thermostat and said temperature-sensing device.

8. A gas burner with a gas flow restrictor as in claim 1 whereby the control panel electrical circuit consists of a microprocessor that analyzes the signals from said thermostat and said temperature-sensing device.

9. A cooktop means adapted for use in food preparation which consists of a burner, a rack to support cooking utensils, an electrically activated gas flow valve, an electrical control panel, an electrical temperature-sensing device means whereby said rack transmits heat which is converted by a resistor means into an electrical signal from said temperature-sensing device to said control panel by means of metal screws which are screwed into said rack, and the first such screw is in direct contact with said rack and also in direct contact with the cooktop frame via a first contact means which is mounted on said frame, and the second such screw is electrically insulated from said rack and said second screw is in direct electrical contact with said control panel via a second contact means which is insulated from said cooktop frame, and to said second screw is also connected said temperature-sensing device, and both the first and second screws can be adjusted in order to make sure that a closed electrical loop will be maintained between said temperature-sensing means and said control panel and the ground of said cooktop frame, with both said screws simultaneously touching said contacts which are mounted on said cooktop frame.

10. An adjustable gas flow restrictor valve which consists of a valve housing that consists of a valve means and a housing that consists of at least two bores and a seat whereby the passage between said two bores can be interrupted by said valve means which is disposed in said housing, and adjustable means communicates with said valve means whereby the “movement” of said adjustable means will change the position of said valve means relative to said seat and the moving of said adjustable means in a way that the position of said valve means will determine the size of the flow of gas between said two bores.

11. A gas cooktop as in claim 1 further consists of a control panel whereby said control panel consists of an adjustable means to control the intensity of the flame once the flame is in the low-intensity cycle.
